(19) United States
(12) Patent Application Publication
(10) Pub. No.: US 2005/0165762 A1
(43) Pub. Date: Jul. 28, 2005

(54) User event matching system and method

(75) Inventor: Joseph Bishop, Sherman Oaks, CA (US)

Correspondence Address: CISLO & THOMAS, LLP, 233 WILSHIRE BLVD, SUITE 900, SANTA MONICA, CA, 90401-1211, US

(73) Assignee: ThinkBig, Inc., a California corporation

(21) Appl. No.: 11/041,105

(22) Filed: Jan. 22, 2005

Related U.S. Application Data
(60) Provisional application No. 60/539,655, filed on Jan. 26, 2004.

(51) Int. Cl. G06F 17/30

(52) U.S. Cl. 707/3

(57) ABSTRACT

A user event matching system comprises a server configured to perform searches of potentially compatible users and events associated therewith. The event search results are ranked based on event attributes and at least one user attendance record. The system also comprises at least one client adapted to communicate with the server. Each client may be utilized for creation of user events and advertisement of the created events to potential attendees.

### CROSS-REFERENCE TO RELATED APPLICATIONS

This application claims the benefit of U.S. Provisional Patent Application No. 60/539,655, filed on Jan. 26, 2004, which is incorporated hereby in its entirety by reference.

### BACKGROUND

Social interaction/networking services use various ways to try and match a user's personal characteristics and priorities with other users for the purpose of setting up personal meetings and possibly establishing a personal relationship. Some of these services require potential users to make personal video presentations and make the same available for screening by other users. Users of such services are typically introduced via the Internet, by mail, telephone, or the like. Most of the social interaction web sites allow a user to review personal information about other users and/or view pictures of the other users, but a person cannot get a real sense of another person's personality and/or interests without meeting directly with the other person. Unfortunately, not every user is comfortable meeting other previously unknown users in a one-on-one situation.

A more efficient, dynamic and user-friendly system is needed to allow users to interact with one or more other potentially compatible users in a social setting. Getting people out from behind their computers to meet other potentially compatible persons in a comfortable social atmosphere would be preferable to a conventional blind date scenario. Instead of users meeting in virtual chat rooms, or making first contact by telephone, e-mail or mail, an initial face-to-face meeting of fairly compatible users at a pre-arranged event, such as a party, social gathering, or on a ride share trip, would be more beneficial to a user desiring social interaction, companionship, friendship or the like.

### SUMMARY

Exemplary embodiments disclosed herein are generally directed to a user event matching system and method.

In accordance with one aspect of the invention, the user event matching system comprises at least one server configured to perform searches of potentially compatible users and events associated therewith. The event search results are ranked based on event attributes and at least one user attendance record. The system also comprises at least one client adapted to communicate with the server. The client is utilized for creation of user events and advertisement of the created events to potential attendees.

In accordance with another aspect of the invention, the user event matching method comprises the steps of creating a user account, creating a user profile, creating a user search agent, and utilizing the search agent to rank other users on a potentially compatible basis. The method also comprises creating an event, conducting an event search, and ranking the event search results based on event attributes and at least one attendance record of the potentially compatible users.

In accordance with yet another aspect of the invention, a computer readable media having instructions stored thereon, which instructions when executed by a computing device, cause the computing device to perform the steps of creating a user account, creating a user profile, creating a user search agent, utilizing the search agent to rank other users on a potentially compatible basis, creating an event, conducting an event search, and ranking the event search results based on event attributes and at least one attendance record of the potentially compatible users.

These and other aspects of the invention will become apparent from a review of the accompanying drawings and the following detailed description of the invention.

### BRIEF DESCRIPTION OF THE DRAWINGS

The invention is generally shown by way of reference to the accompanying drawings in which:

FIG. 1 is a block diagram of a user event matching system in accordance with an exemplary embodiment of the present invention; and

FIG. 2 is a flow chart of a user event matching method in accordance with an exemplary embodiment of the present invention.

### DETAILED DESCRIPTION

The detailed description set forth below in connection with the appended drawings is intended as a description of exemplary embodiments and is not intended to represent the only forms in which the exemplary embodiments may be constructed and/or utilized. The description sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of the present invention.

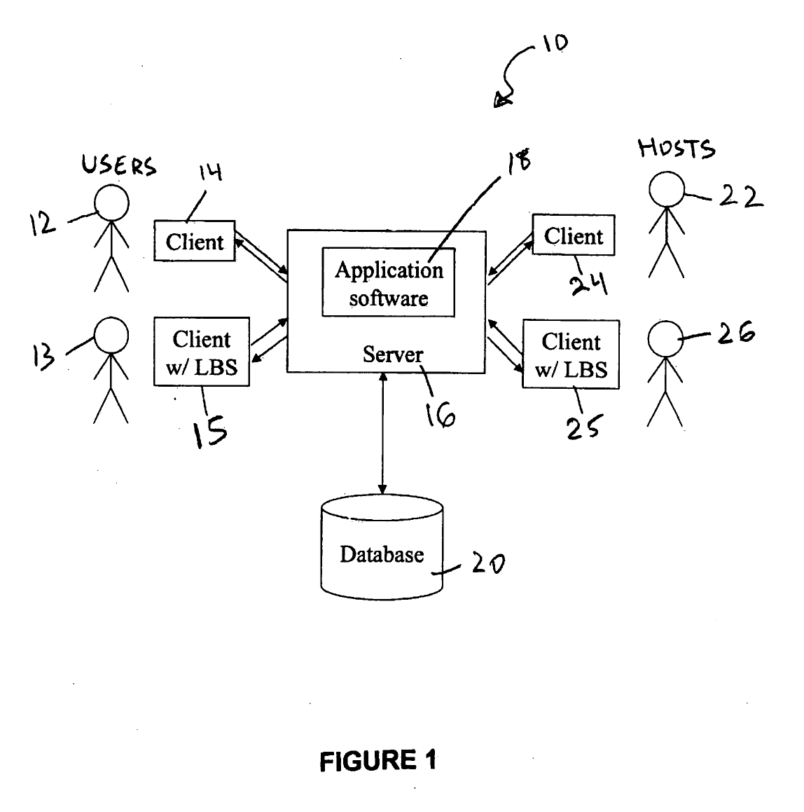

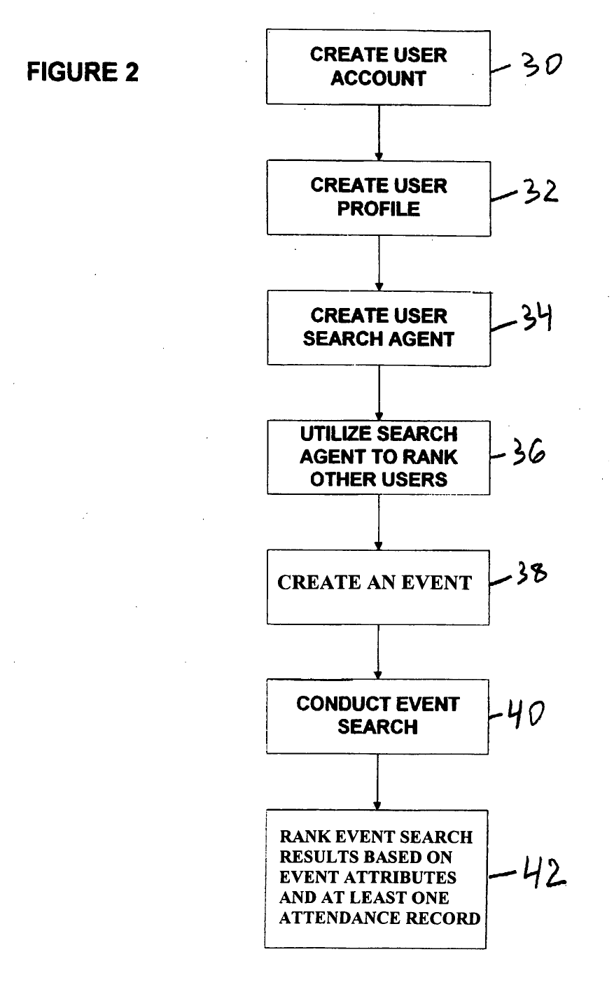

Some embodiments of the invention will be described in detail with reference to the related drawings of FIGS. 1-2. Additional embodiments, features and/or advantages of the invention will become apparent from the ensuing description or may be learned by practicing the invention. In the figures, the drawings are not to scale with like numerals referring to like features throughout both the drawings and the description.

For purposes of describing the general principles of the present invention, the term “event” may be used to describe parties, social gatherings, ride share trips, and other activities where more than one person is involved. The activity does not necessarily have to be a one-on-one activity, as with a blind date, but it may entail an environment of multiple possibilities for companionship. Some events may only have a host and user present, i.e. a ride share. Such “one-on-one” events would occur if there are only two people interested in such an event, activity, ride share, or social gathering.

In accordance with an exemplary embodiment of the present invention, a user event matching system 10 (FIG. 1) utilizes a client-server architecture adapted to allow system users to create profiles of themselves. For example, a user 12 may invoke a client 14 to send an information search request to a server 16, as generally depicted in FIG. 1. Typically, a client is an application that runs on a personal computer, workstation or the like and relies on a server to perform some operations. For example, an e-mail client is an application that enables a user to send and receive e-mail.

Server 16 may be programmed via application software 18 to perform information searches and/or other tasks, such as creating a user profile, search agent(s) and the like. Server 16 is operatively linked to a database 20 which stores data related to the information search request sent by user 12. Database 20 may be installed on server 16, or may reside on a separate device configured to communicate with server 16 via an appropriate communication link. After retrieving the needed information, server 16 transmits the same to user 12 via client 14 (FIG. 1). User 12 may create search agents of other users, in order to find persons of interest. An “agent” is essentially a program that performs some information gathering or processing task in the background. Typically, agents are assigned well-defined tasks.

One search agent, in accordance with the general principles of the present invention, may be generally define as a user-defined search for events that the user would like to attend. When executed, the search agent generates a list of events that the user may be interested in attending. The search agent may be adapted to list events in the order of potential importance to the user. This potential importance to the user is generated by calculating or estimating the compatibility of the user to other event users (host or other persons already registered for the event), in addition to the event requirements that the user has specified in the search, such as activities and location.

The location of the event may be a fixed geographical location, or may follow a Location Based Service (LBS) or Global Positioning System (GPS) measurement, thus creating a “location that is dynamic” based on LBS or GPS data. The term “location” may be used to describe either fixed or dynamic geographical positions and may be based on GPS/LBS data or may include start/end positions as in a ride share activity.

The calculation of compatibility to other event users may be based on the set of users that have already replied to an inquiry whether they would be attending an upcoming event. The calculation of compatibility to other event users may also be based on the past history of users that have replied to attendance inquiries for similar types of events or similar events. Similar events are events that were previously hosted by the same host, such as host 22 of FIG. 1, as an upcoming event, or events that were previously hosted by another user that has a similar compatibility ranking as that between the user and the host of the upcoming event.

Host 22 may utilize client 24 to communicate with server 16, as generally illustrated in FIG. 1. Host 22 may be compensated monetarily for hosting an event. Compensation may be a fixed monetary amount per event, or in the case of other events (i.e. ride share) a monetary amount that is incremental based on time and/or distance traveled. Monetary compensation may be “brokered” through user event matching system 10, i.e. system 10 may be adapted to accept payments from users or users and arrange for hosts to be compensated by common banking methods.

In accordance with another exemplary embodiment of the present invention, the client-server architecture of user event matching system 10 may be configured to allow user 12 to create an account, step 30 of FIG. 2, by specifying a username, a password, and an email address for communication about the account with the new user. A pseudocode example regarding creation of a new user account is included herein below, as follows:

User.name = <user defines username>
User.password = <user defines password>
User.contact.email = <user defines contact email>

Pseudocode may be viewed as the outline of a program, written in a form that may be converted into real programming statements. Pseudocode can neither be compiled nor executed. Pseudocode, generally, allows the programmer to concentrate on algorithms without worrying about the syntactic details of a particular programming language.

User 12 may utilize client 14 and server 16 to create a profile, step 32 of FIG. 2, by selecting or defining values or ranges of values of provided fields that most closely describe the user and his/her interests. Examples of fields provided in a sample profile template may include body type, race, religion, academic background, favorite activities, profession, desired profession, and other personal descriptors of users, such as mind, body, soul, wealth, family, virtues, vices and/or the like. There are a variety of ways to describe a person in a “user profile.” The following examples are neither meant to be all-inclusive with respect to system capability, nor do the following examples describe required data for successful operation of the system. Within any profile field, any value may be pre-defined as a “default” value, and system 10 will still operate, if user 12 fails to select a value other than the pre-defined default value. A pseudocode example regarding creation of a user profile is included herein below, as follows:

User.profile.basics.age = <user defines age>
User.profile.basics.gender = <user defines gender>
User.profile.basics.race = <user defines race>
User.profile.basics.location = <user defines location (fixed and/or LBS/GPS service

data> >

User.profile.mind.educationLevel = <user defines education level>
User.profile.mind.streetSmarts = <user defines street smarts coefficient>
User.profile.mind.bookSmarts = <user defines book smarts coefficient>
User.profile.body.type = <user defines body type>
User.profile.body.skinColor = <user defines skin color>
User.profile.body.hairColor = <user defines hair color>
User.profile.body.hair = <user defines hair>
User.profile.body.facialHair = <user defines facial har>
User.profile.body.bodyHair = <user defines body hair>
User.profile.spirit.innerAge = <user defines inner age>
User.profile.spirit.previousLife = <user defines previous Life value>
User.profile.riches.income = <user defines income>
User.profile.riches.current.Occupation = <user defines current occupation>
User.profile.riches.desiredOccupation = <user defines desired occupation>
User.profile.virtues.goodSamaritan = <user defines good Samaritan coefficient>
User.profile.virtues.cleanliness = <user defines cleanliness coefficient>
User.profile.vices.smoker = <user defines smoker type>
User.profile.vices.drinker = <user defines drinker type>
User.profile.vices.gambler = <user defines gambler type>
User.profile.activities.outdoors = <user defines desired outdoor activities>
User.profile.activities.indoors = <user defines desired indoor activities>
User.profile.activities.spectator = <user defines desired spectator activities>
User.profile.family.type = <user defines family type (married with kids, single with

kids, etc)>

User.profile.family.numberKids = <user defines number of kids>

User 12 may also utilize the client-server architecture of user event matching system 10 to search for other users by selecting or defining values or ranges of values of provided fields that most closely describe another user “type” that he/she would be interested in meeting and developing a relationship. The relationship may be platonic, romantic, or activity based. User 12 specifies the importance of the value of a field, thereby providing a weighting of importance to one attribute over another.

As user 12 selects or defines a value or range of values for each provided field, the user is narrowing the search of the available user set. This narrowing of the search of the available user set will result in fewer user matches, but will increase the likelihood that the users listed in the search result set are closer to the specified user “type”. Within any profile field, any value may be pre-defined as a “default” value, and system 10 will still operate, if user 12 fails to select a value other than the pre-defined default value. Additionally, with any search field importance, the value can be left as a default, and system 10 will still operate with all values being of equal importance.

Once user 12 has created a search definition for another user “type”, the search definition can be saved, i.e. a user-defined search agent has been created, step 34 of FIG. 2, of other users. This search agent searches for other users and may be set to run as a batch job n-times a day, or the results may be dynamically generated at the time user 12 decides to review the results. A pseudocode example regarding creation of such a search agent is included herein below, as follows:

User.memberSearch.basics.age.importance = <importance of age>
User.memberSearch.basics.age.valueMin = <minimum age of user sought>
User.memberSearch.basics.age.valueMax = <maximum age of user sought>
User.memberSearch.basics.gender.importance = <importance of gender>
User.memberSearch.basics.gender.value = <gender of user sought>
User.memberSearch.basics.race.importance = <importance of race(s)>
User.memberSearch.basics.race.value = <race(s) of user sought>
User.memberSearch.mind.educationLevel.importance = <importance of education

level(s)>

User.memberSearch.mind.educationLevel.value = <education level(s) of user sought>
User.memberSearch.mind.streetSmarts.importance = <importance of street smarts

coefficient>

User.memberSearch.mind.streetSmarts.value = <street smarts coefficient of user

sought>

User.memberSearch.mind.bookSmarts.importance = <importance of book smarts

coefficient>

User.memberSearch.mind.bookSmarts.value = <book smarts coefficient of user

sought>

User.memberSearch.body.type.importance = <importance of body type>
User.memberSearch.body.type.value = <body type of user sought>
User.memberSearch.body.skinColor.importance = <importance of skin color>
User.memberSearch.body.skinColor.value = <skin color of user sought>
User.memberSearch.body.hairColor.importance = <importance of hair color>
User.memberSearch.body.hairColor.value = <hair color of user sought>
User.memberSearch.body.hair.importance = <importance of hair>
User.memberSearch.body.hair.value = <hair of user sought>
User.memberSearch.body.facialHair.importance = <importance of facial hair>
User.memberSearch.body.facialHair.value = <facial hair of user sought>
User.memberSearch.body.bodyHair.importance = <importance of body hair>
User.memberSearch.body.bodyHair.value = <body hair of user sought>
User.memberSearch.spirit.innerAge.importance = <importance of inner age>
User.memberSearch.spirit.innerAge.value = <inner age of user sought>
User.memberSearch.spirit.previousLife.importance = <importance of previous Life

value>

User.memberSearch.spirit.previousLife.value = <previous Life value of user sought>
User.memberSearch.riches.income.importance = <importance of income>
User.memberSearch.riches.income.value = <income of user sought>
User.memberSearch.riches.current.Occupation.importance = <importance of current

occupation>

User.memberSearch.riches.current.Occupation.value = <current occupation of user

sought>

User.memberSearch.riches.desiredOccupation.importance = <importance of desired

occupation>

User.memberSearch.riches.desiredOccupation.value = <desired occupation of user

sought>

User.memberSearch.virtues.goodSamaritan.importance = <importance of good

Samaritan coefficient>

User.memberSearch.virtues.goodSamaritan.value = <good Samaritan coefficient of

user sought>

User.memberSearch.virtues.cleanliness.importance = <importance of cleanliness

coefficient>

User.memberSearch.virtues.cleanliness.value = <cleanliness coefficient of user

sought>

User.memberSearch.vices.smoker.importance = <importance of smoker type>
User.memberSearch.vices.smoker.value = <smoker type of user sought>
User.memberSearch.vices.drinker.importance = <importance of drinker type>
User.memberSearch.vices.drinker.value = <drinker type of user sought>
User.memberSearch.vices.gambler.importance = <importance of gambler type>
User.memberSearch.vices.gambler.value = <gambler type of user sought>
User.memberSearch.activities.outdoors.importance = <importance of desired outdoor

activities>

User.memberSearch.activities.outdoors.value = <desired outdoor activities of user

sought>

User.memberSearch.activities.indoors.importance = <importance of desired indoor

activities>

User.memberSearch.activities.indoors.value = <desired indoor activities of user

sought>

User.memberSearch.activities.spectator.importance = <importance of desired

spectator activities>

User.memberSearch.activities.spectator.value = <desired spectator activities of user

sought>

User.memberSearch.family.type.importance = <importance of family type>
User.memberSearch.family.type.value = <family type of user sought>
User.memberSearch.family.numberKids.importance = <importance of number of

kids>

User.memberSearch.family.numberKids.value = <number of kids of user sought>

User 12 reviews the search results generated by the search agent. The generated search results are presented to user 12 with an ordering or ranking of users from highest to lowest, step 36 of FIG. 2. The user ranking allows user 12 to determine who is more or less “potentially compatible”. Generally, for a given user, the more user profile entries that are important to the user and match the user's criteria, as defined in his/her “other user” search agent, the higher the ranking of that user in the users search result set generated by the search agent. A pseudocode example showing how a user ranking may be generated is included hereinbelow, as follows:

REM Generate a ranking of users in system based on users memberSearch
REM criteria.
For each user(i) in system

If user selects only users attraction to users
then

user.memberSearch.user(i).rankvalue = Function RankOfMember(User,user(i))

else if user selects only users attraction to user
then

user.memberSearch.user(i).rankvalue = Function RankOfMember(user(i),User)

else if user selects cumulative attraction between user and users
then

user.memberSearch.user(i).rankvalue = Function RankOfMember(User,user(i))

+ Function

RankOfMember(user(i),User)

else if user selects cross-attraction between user and users

user.memberSearch.user(i).rankvalue = Function RankOfMember(User,user(i))

* Function

RankOfMember(user(i),User)

end if

Next user(i)
REM Sort the users memberSearch based on rank values
Sort(User.memberSearch.user(i), rank Value)
REM Display user results of users memberSearcb based on rank Value from Highest
REM value to lowest value
For each rankValue Highest to lowest

Display(User.memberSearch.user(rankValue))

Next rankValue
REM Function RankOfMember calculates the ranking value of a single user based
REM on the users memberSearch criteria
Function RankOfMember(user,user(i))
Begin RankOfMember

REM Initialize rankValue to zero
user(i).rankValue = 0
REM Calculate the total value of user based on the summation of the individual
REM user.memberSearch.<field value> and the user.memberSearch.<field

importance>

For each user.memberSearch.<field value>

REM calculate the correlation of user.profile.<field value> and
REM user.memberSearch.<field value>
correlationUserMemberValue = Function Correlation(user(i).profile<field value>

user.memberSearch.<field

value>)

if (correlationUserMemberValue > 0)
then
user(i).rankValue = user(i).rankValue

+ ( correlationUserMemberValue

* user.memberSearch.<field importance>)

endif

Next user.memberSearch.<field value>
return user(i).rankValue

End RankOfMember
REM Function Correlation calculates the correlation between the

user.memberSearch.<field value>

REM and the user(i).profile.<field value>
Function Correlation(user(i).profile<field value>,user.memberSearch.<field value>)
Begin Correlation

REM Initialize correlation to zero
correlation = 0
REM determine the correlation between the users profile <field value> and the
REM user.memberSearch.<field value>
if (user(i).profile<field value> = user.memberSearch.<field value>)
then

correlation = 1.0

else if (user(i).profile<field value> in set of user.memberSearch.<field values>)
then

correlation = <func of how much user and userSearch field values>

endif
return correlation

End Correlation

Users, commercial vendors, or system support staff may create events, step 38 of FIG. 2, on the system web site or other computer interface. The creator of an event is generally referred to as “host,” e.g. hosts 22, 26 of FIG. 1. These events are typically open events for any web site user or other user(s) to attend. However, such events may be targeted to specific users or users of the system web site. A pseudocode example showing how an event may be created by hosts, such as hosts 22, 26 of FIG. 1, is included herein below, as follows:

Event.host = <host defines self as host>
Event.host2 = <host defines alternate host>
Event.time.begin = <host defines beginning time of event>
Event.time.end = <host defines end time of event>
Event.location.name = <host defines location name>
Event.location.position = <host defines location position
(fixed, LBS/GPS data, or start

and end positions as in ride share / carpool)>

Event.location.languages = <host defines locations
languages spoken>
Event.location.food = <host defines locations food served>
Event.location.drinks = <host defines locations drinks served>
Event.location.activities = <host defines locations
activities provided>
Event.other.activities = <host defines other activities that will
occur at event>
Event.intent = <host defines intent of event in the sense of
singles, romantic,

platonic...etc>

Event.cost = <cost listed is either based on price range, fixed
RSVP cost, or based on

incremental costs per distance or time measurement (ie. Ride share

or carpool)>
Event.guests.user(i) = <host defines some event users, may be
only host(s) to begin

with>

Users may define a search for an event based on a time window for the event, the location (fixed or dynamic—by following LBS/GPS data) of the event, and other search criteria such as cost range, languages spoken, food served, drinks served, activities provided as well as the intent of the event, e.g. singles' party, romantic social function, couples' function, family function, etc. For example, user 13 utilizes client 15, which has LBS capability, to communicate with server 16, as generally depicted in FIG. 1. A pseudocode example showing how an event search may be defined is included herein below, as follows:

User.eventSearch.time.begin = <beginning time range of
event sought>
User.eventSearch.time.end = <ending time range of event sought>
User.eventSearch.location = <position of event (fixed,
GPS/LBS data, or start and end

positions)>

User.eventSearch.languages = <languages spoken at event sought>
User.eventSearch.food.importance = <importance of food served
at event sought>
User.eventSearch.food.value = <food served at event sought>
User.eventSearch.drinks.importance = <importance of drinks
served at event sought>
User.eventSearch.drinks.value = <drinks served at event sought>
User.eventSearch.activities.importance = <importance of activities
provided at event

sought>

User.eventSearch.activities.value = <activities
provided at event sought>
User.eventSearch.intent.importance = <importance of intent of
event sought>
User.eventSearch.intent.value = <intent of event sought>

User 12 conducts the defined event search, step 40 of FIG. 2, with the results of the event search being ranked by users who have replied that they would attend the event or by users who are expected to reply in the future that they would attend the event. User event matching system 10 may be configured to predict users that are expected to reply either by (a) using click-through technology to measure which users have viewed the event listing, (b) using past attendance reply information for users who attended similar events, (c) using past attendance reply information for users that attended events from the same host, or (d) using user-to-user similarity comparisons coupled with the methods of (a), (b) or (c). Click-through technology generally refers to a web site user clicking on a web advertisement and visiting the advertiser's web site. The “click” rate measures the amount of times an advertisement is clicked versus the amount of times it's viewed.

When user 12 reviews the results of the event search, the results are presented to user 12 with an ordering or ranking of events from highest to lowest. This is an attempt to present the events to user 12 in a way that lets the user know which event is more or less “potentially compatible” in terms of both event attributes (cost, location, food, time, activities, etc.) and the users that have replied that they would attend the event or are expected to reply that they would attend the event, step 42 of FIG. 2.

Essentially, for a given event the more event attributes that are important to the user, as define in the user event search as well as the guests of the event that are higher ranking users from the user's search agent, the higher the ranking of the event. If two or more events match the search criteria for the user in terms of event attributes, then the event rankings will be affected only by a cumulative guest score. This cumulative guest score would be different for each user searching for events, as it is a summation of that user's search agent rankings for users that are guests of the event. A pseudocode example showing how an event search results ranking is generated is included herein below, as follows:

REM Generate a ranking of events in system based on users memberSearch
REM criteria and users eventSearch criteria
For each event(k) in system

User.eventSearch.event(k).rankvalue = Function RankOfEvents(User,event(k))

Next event(k)
REM Sort the users eventSearch based on rank values
Sort(User.eventSearch.event(k), rankValue)
REM Display event results of users eventSearch based on rankValue from Highest
REM value to lowest value
For each rankValue Highest to lowest

Display(User.eventSearch.event(rankValue))

Next rankValue
REM Function RankOfEvent calculates the ranking value of a single user based
REM on the users eventSearch criteria
Function RankOfEvent(user,event(k))
Begin RankOfEvent

REM Initialize rankValue to zero
event(k).rankValue = 0
REM Calculate the total value of event based on the summation of the individual
REM user.eventSearch.<field value> and the user.eventSearch.<field importance>
For each user.eventSearch.<field value>

REM calculate the correlation of event.<field value> and
REM user.eventSearch.<field value>
correlationUserEventValue = Function Correlation(event(k).<field value>

user.eventSearch.<field

value>)

if (correlationUserEventValue> 0)
then

event(k).rankValue = event(k).rankValue

+ ( correlationUserEventValue

* user.eventSearch.<field importance> )

endif

Next user.eventSearch.<field value>
REM Include the total value of event based on the summation of the individual
REM guests of event rank in users.memberSearch results
For each event(k).guest

user(i) = event(k).guest
REM add up the user.memberSearch rankings of the guests of the event
event(k).rankValue = event(k).rankValue

+ user.memberSearch.user(i).rankvalue

Next event(k).guest
return event(k).rankValue

End RankOfEvent

Having generated a ranking based on event attributes and at least one attendance record, user 12 views the events based on the event score. In general, the user has “greater potential” for a satisfying time at a higher ranked event. User 12 decides which event to attend and communicates his/her decision to server 16 via client 14. Server 16 is configured by application software 18 to add users (who reply that they would attend the event) to an event guest list. A pseudocode example reflecting that process is included herein below, as follows:

REM User RSVPs for event
REM increment event guest count i
i = i + 1
Event.guests.user(i) = user
REM guest establishes a RSVP credit for host compensation if required
Event.guests.memberRSVPCredit(i) = RequiredRSVPAmount

The event score is a dynamic value. Every time a user, such as user 12 or user 13, signs up to attend an event, the event score is altered accordingly. In addition, based on the user's LBS data, events may become “closer” in proximity and thus become higher ranked based on the dynamic location of the user. With the dynamic nature of the event score, an event can grow through the rankings in a user's event search result list. For instance, if a user Ua is compatible with a particular user Mb, and that user is not registered for an event, then the events presented to user Ua would not have high rankings. If user Mb registers for an event Ec, then event Ec would from then on have a higher ranking in the event search set for user Ua. Likewise, when user Ua replies that he/she would be attending event Ec, there may be additional users that are compatible with user Ua and thus the score for Ec would become higher for those users that are compatible with Ua.

An exemplary process showing how an event may be created from a host perspective is included herein below, as follows:

Step 1. A host, such as host 22 or host 26 of FIG. 1, connects to a web site associated with user event matching system 10 and initiates a pre-defined “create event” wizard.

Step 1.1. The host enters the names of co-hosts for the event.

Step 1.2. The host enters the title of the event.

Step 1.3. The host specifies the intent of the event (e.g., singles get-together, family night, etc.) Step 1.4. The host enters a description of the event.

Step 1.5. The host enters “start” and “end” times of the event.

Step 1.6. The host chooses a location for the event from a pre-set and pre-approved list of event locations. Alternatively, the host creates or enters a new location for the event. The event may be based on GPS/LBS data or “start” and “end” positions as in a ride share event. If the host enters a new commercial location, the host would subsequently contact the proprietor at the commercial location in order to make arrangements for events of a number of guests above a standard table seating count. Other ways of setting up a new commercial location may be utilized, as needed.

Step 1.7. The host enters the type of food, drinks, and activities associated with the event.

Step 1.8. The host enters the number of desired persons for the event.

Step 1.9. The host specifies desired attendees for the event.

Step 1.10. The host submits the event for listing on the system web site or other suitable system interface.

Step 1.11. A “web site event” wizard e-mails the host, co-hosts, and desired attendees regarding the details of the event. Other communication means may be utilized, such as text messaging, chat rooms and/or the like, provided there is no deviation from the intended scope and spirit of the present invention.

Step 1.12. The host, possible co-hosts and possible desired attendees have become the initial guests who have replied that they would be attending the event. This set of guests becomes the seed for attracting other available users to the event.

Step 2.0. Users with access to the system web site visit the web site and search for appropriate events.

Step 2.1. A user searches for events in the same time frame and in the same city as the hosted event, or based on user's LBS readings or data.

Step 2.2. The user views the event that a particular host has created. The event's ranking, in the event search results list, is based on how “compatible” or “attracted” the user is to the current set of guests of the event. The more “compatible” or “attracted” a user is to the guest(s) of the event, the higher the ranking the event will receive in the user's event search results list. The user is aware that an event that is higher in the search results list is more likely to have “compatible” guests.

Step 2.3. The user replies that he/she would be attending the event, which results in his/her name being added to the guest list for the event.

Step 2.4. The guest list for the event grows with other system users being able to view the event rise in their respective event search results lists.

Step 3.0. Meanwhile the host and co-hosts of the event are monitoring the event status. For example, host 26 utilizes client 25, which has LBS capability, to communicate with server 16, as generally shown in FIG. 1. Similarly, host 22 uses client 24 (FIG. 1) to communicate with server 16. Each of clients 14, 15, 24 and 25 may be operatively connected to server 16 via packet-switching technology, or other suitable means, as needed.

Step 3.1. The host and co-hosts receive a system notification for each user that has replied that he/she would be attending the event.

Step 3.2. The host and co-hosts watch the event ranking rise in the event search results for the given time and location.

Step 3.3. The host and co-hosts communicate with guests of the event via e-mail, virtual chat rooms, text messaging, and/or web logs (blogs). A blog is a web page that serves as a publicly accessible personal journal for an individual user. Typically updated daily, blogs often reflect the personality of the author.

Step 3.4. The host and co-hosts facilitate introductions between signed guests before the event begins.

Step 4.0. Meanwhile, the guests are monitoring the event status as well.

Step 4.1. A guest communicates with other guests of the event through e-mail, virtual chat room, text messaging, and/or blogs. This inter-guest communication is allowed if guests have their individual security settings established appropriately.

Step 4.2. An event guest reviews in advance of the event other guests' web site profiles to find common interests and topics to talk about. This inter-guest viewing of web site profiles is allowed if the guests have their individual security settings established appropriately.

Step 4.3. For an event guest, the event “virtually begins” as soon as he/she replies that he/she would be attending the event. The event guest may get to know other guests of the event them before the event commences. This facilitates guest introductions and allows the user to feel as part of a select community before the event actually commences.

Step 5.0. The host confirms the details of the event a pre-set time period (e.g., 48 hours) in advance of the event with details on the event location. The event location may be based on LBS reading at the time of the event, or a system server may relay LBS information to guests at an appropriate time.

Step 6.0. In another pre-set time period in advance of the event, the guest finds out the actual location of the event.

Step 7.0. The event takes place.

Step 7.1. The host and co-hosts make sure every guest is introduced.

Step 7.2. The guests have a pleasant time and make some new friends.

Step 7.3. The event comes to an end.

Step 8.0. The event is reviewed by the guests (users that have attended the event).

Step 8.1. The users provide a score and review of the host and co-hosts.

Step 8.2. The users provide a score and review of the location and location's staff.

Step 8.2. The users provide an overall score and review of the event.

Step 9.0. The user feedback is introduced into the user event matching system of the present invention via an associated web site or other suitable interface.

Step 9.1. The host and co-hosts that have a good review and score become eligible system perquisites, e.g. a monthly drawing for a monetary credit toward their next event or other suitable system services and/or products.

Step 9.2. The location's review and score contributes to the location's ranking in a pre-set system location list that hosts use to pick locations for events.

Step 9.3. The host cashes out the monetary credits for hosting events or in the case of ride share activity for providing the ride. If the host does cash out the monetary credits, the host receives payment by common banking methods.

The user event matching system of the present invention affords plenty of opportunities for hosts to create events for users who would normally not attend such events. Moreover, the user event matching system of the present invention may be adapted to allow users and hosts to set up and exchange information via the Internet from their own homes via their own personal computers, or when traveling, via laptops, PDAs (Personal Digital Assistants), mobile telephone sets, and/or the like.

A person skilled in the art would appreciate that the exemplary embodiments described hereinabove are merely illustrative of the general principles of the present invention. Other modifications or variations may be employed that are within the scope of the invention. Thus, by way of example, but not of limitation, alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

1. A user event matching system, comprising;
at least one server configured to perform searches of potentially compatible users and events associated therewith, said event search results being ranked based on event attributes and at least one user attendance record; and
at least one client adapted to communicate with said at least one server, said at least one client being utilized for creation of user events and advertisement of the created events to potential attendees.

2. The user event matching system of claim 1, wherein said at least one user attendance record includes users who are going to attend the advertised event.

3. The user event matching system of claim 1, wherein said at least one user attendance record includes users who are expected to attend the advertised event, the advertised event being created by at least one host.

4. The user event matching system of claim 3, wherein the number of users who are expected to attend the advertised event is determined by the use of click-through technology.

5. The user event matching system of claim 3, wherein the number of users who are expected to attend the advertised event is determined by the use of past attendance reply information for users who attended similar events.

6. The user event matching system of claim 3, wherein the number of users who are expected to attend the advertised event is determined by the use of past attendance reply information for users that attended events created by said at least one host.

7. The user event matching system of claim 4, wherein the number of users who are expected to attend the advertised event is further determined via user-to-user similarity comparisons.

8. The user event matching system of claim 5, wherein the number of users who are expected to attend the advertised event is further determined via user-to-user similarity comparisons.

9. The user event matching system of claim 6, wherein the number of users who are expected to attend the advertised event is further determined via user-to-user similarity comparisons.

10. The user event matching system of claim 1, wherein said at least one client has LBS (Location Based Service) capability.

11. The user event matching system of claim 1, wherein said at least one server is configured via application software to perform searches of potentially compatible users and events associated therewith.

12. The user event matching system of claim 1, wherein said at least one server is configured via application software to rank event search results based on event attributes and at least one user attendance record.

13. The user event matching system of claim 1, wherein said at least one server is operatively coupled to at least one database.

14. The user event matching system of claim 1, wherein said at least one server is configured via application software to allow the creation of a user account.

15. The user event matching system of claim 1, wherein said at least one server is configured via application software to allow the creation of a user profile.

16. The user event matching system of claim 1, wherein said at least one server is configured via application software to allow the creation of a user search agent.

17. The user event matching system of claim 16, wherein said at least one server is adapted to utilize said created search agent to rank other users on a potentially compatible basis.

18. The user event matching system of claim 1, wherein at least one of the created events includes a ride share activity.

19. The user event matching system of claim 3, wherein said at least one host defines the location of the created event.

20. The user event matching system of claim 19, wherein the defined location is fixed.

21. The user event matching system of claim 19, wherein the defined location is dynamic, said dynamic location being based on LBS (Location Based Service) data.

22. The user event matching system of claim 19, wherein the defined location is dynamic, said dynamic location being based on GPS (Global Positioning System) data.

23. The user event matching system of claim 3, wherein said at least one host defines the start and end positions of the created event.

24. The user event matching system of claim 23, wherein the defined start and end positions are associated with a ride share activity.

25. The user event matching system of claim 21, wherein at least one of said event search results is based on proximity to LBS data.

26. The user event matching system of claim 3, wherein said at least one host is compensated monetarily for hosting an event.

27. The user event matching system of claim 26, wherein said host compensation is a fixed monetary amount per event.

28. The user event matching system of claim 26, wherein said host compensation is an incremental monetary amount.

29. The user event matching system of claim 28, wherein said incremental monetary amount is based on time and distance traveled during a ride share activity.

30. The user event matching system of claim 28, wherein said incremental monetary amount is based on time spent during a ride share activity.

31. The user event matching system of claim 28, wherein said incremental monetary amount is based on distance traveled during a ride share activity.

32. The user event matching system of claim 26, wherein said at least one server is adapted to accept payments from users via said at least one client.

33. The user event matching system of claim 26, wherein said at least one server is adapted to arrange compensation for said at least one host via said at least one client by common banking methods.

34. The user event matching system of claim 17, wherein the more compatible a user is to an event guest, the higher the ranking of the event in said event search results.

35. A user event matching method, comprising the steps of:
creating a user account;
creating a user profile;
creating a user search agent;
utilizing said search agent to rank other users on a potentially compatible basis;
creating an event;
conducting an event search; and
ranking the event search results based on event attributes and at least one attendance record of the potentially compatible users.

36. The user event matching method of claim 35, wherein the more compatible a user is to an event guest, the higher the ranking of the event in the event search results.

37. The user event matching method of claim 36, wherein at least one host defines the location of a created event.

38. The user event matching method of claim 37, wherein the define location is fixed.

39. The user event matching method of claim 37, wherein the defined location is dynamic, said dynamic location being based on LBS (Location Based Service) data.

40. The user event matching method of claim 37, wherein the define location is dynamic, said dynamic location being based on GPS (Global Positioning System) data.

41. Computer readable media having instructions stored thereon, which instructions when executed by a computing device, cause the computing device to perform the steps of:
creating a user account;
creating a user profile;
creating a user search agent;
utilizing said search agent to rank other users on a potentially compatible basis;
creating an event;
conducting an event search; and
ranking the event search results based on event attributes and at least one attendance record of the potentially compatible users.

42. The computer readable media of claim 41, wherein the more compatible a user is to an event guest, the higher the ranking of the event in the event search results.

43. The computer readable media of claim 42, wherein at least one host defines the location of a created event.

44. The user event matching method of claim 43, wherein the defined location is fixed.

45. The user event matching method of claim 44, wherein the defined location is dynamic, said dynamic location being based on LBS (Location Based Service) data.

46. The user event matching method of claim 44, wherein the define location is dynamic, said dynamic location being based on GPS (Global Positioning System) data.
